(19) United States
(12) Patent Application Publication
(10) Pub. No.: US 2010/0023360 A1
(43) Pub. Date: Jan. 28, 2010

(54) SYSTEM AND METHOD FOR QUANTITATIVE ASSESSMENT OF THE AGILITY OF A BUSINESS OFFERING

(76) Inventor: Easwaran G. Nadhan, Naperville, IL (US)

Correspondence Address: BAKER BOTTS L.L.P., 2001 ROSS AVENUE, 6TH FLOOR, DALLAS, TX, 75201-2980, US

(21) Appl. No.: 12/178,961

(22) Filed: Jul. 24, 2008

(51) Int. Cl. G06Q 10/00

(52) U.S. Cl. 705/7

(57) ABSTRACT

In a particular embodiment, a method for measuring and assessing the agility of a business offering that includes creating a plurality of agility factors that can be used to measure a responsiveness of a business offering to change. The method further includes assigning a weight to each agility factor. Each weight indicates a relevant contribution of an associated agility factor to the responsiveness of the business offering. The method further includes receiving user inputs of agility values for at least a portion of the plurality of agility factors and using the user inputs of agility values and the weight assigned to each agility factor to calculate an agility result. The agility result provides a quantitative assessment of the adaptability of the business offering.

### TECHNICAL FIELD OF THE INVENTION

The present invention relates generally to business offerings and more particularly to systems and methods for the quantitative assessment of the agility of a business offering.

### BACKGROUND

Customer expectations from organizations providing business offerings are changing. Customers are demanding that organization change business products to accommodate their needs, not that they change to accommodate the ways of the offered products. To cope with these forces, the business products offered by these organizations must become more agile. Product offerings built on rigid Information Technology (IT) systems originally designed to optimize functional silos result in inefficient, fragmented business processes. Thus, there is a need for business solutions that are more flexible and adaptable. Currently, agility cannot be accurately measured, however. Typically, the degree to which a solution is agile is a judgment made by the architect. While such judgments are based on the experience of the architect, the judgments are subjective. Agility is typically sensed rather than measured. Accordingly, an agility assessment provided by one architect may differ from that provided by another architect. There exists no clear measure of how agile a given solution or offering is. Therefore, there it would be desirable to have a method, system, and computer program product for quantitatively assessing the adaptability of a business offering.

### SUMMARY OF THE INVENTION

According to the present invention, disadvantages and problems associated with previous techniques for assessing the agility of a business offering may be reduced or eliminated.

In certain embodiments, a method for measuring and assessing the agility of a business offering that includes creating a plurality of agility factors can be used to measure a responsiveness of a business offering to change. The method further includes assigning a weight to each agility factor. Each weight indicates a relevant contribution of an associated agility factor to the responsiveness of the business offering. The method further includes receiving user inputs of agility values for at least a portion of the plurality of agility factors and using the user inputs of agility values and the weight assigned to each agility factor to calculate an agility result. The agility result provides a quantitative assessment of the adaptability of the business offering.

Particular embodiments of the present invention may provide one or more technical advantages. Conventional techniques for assessing the agility of a business offering typically rely on guesswork and intuition. Previous and existing solutions typically require an individual person to manually determine the adaptability of a business offering. Such assessments are highly subjective and are typically not repeatable—sometimes being nothing more than a wild guess.

Certain embodiments of the present invention enable an individual to calculate a quantitative measurement of the agility of a business offering. In certain embodiments, a worksheet or other tool is provided that assesses the business offering based on a number of factors related to the characteristics of the business offering. The factors are identified based on industry expertise and are objectively applied to business offerings. For example, the worksheet takes into account various standardized factors that are considered for each business offering. As a result, the degree to which an offering is agile is an objective determination based on a process consistently applied to all offerings. The agility measurement does not fall victim to the subjective judgments made by an architect. Using the agility tool described herein, agility is measured rather than sensed.

In certain embodiments, the agility of a business offering may be assessed for different phases during the development of the business offering. For example, in particular embodiments, where the development of the business offering progresses from a validate phase to a plan phase to a design phase, the agility of the business offering during each of these phases may be calculated. It may be desirable, for example, to determine if agility increases as the business offering progresses through the different phases. In a particular embodiment, agility may be calculated at the end of each phase and then may be summed to identify a total agility result upon completion of one or more of these phases.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 depicts a block diagram illustrating a general purpose computer that may be used for measuring the agility of a business offering, in accordance with one embodiment of the present invention;

FIG. 2A depicts a flow diagram illustrating the various phases for the development of a business offering, in accordance with one embodiment of the present invention;

FIG. 2B depicts a block diagram illustrating an exemplary methodology including various factors that may be used in measuring the agility of a business offering, in accordance with one embodiment of the present invention;

FIG. 3 depicts a block diagram illustrating an exemplary agility tool worksheet for calculating the agility of a business offering, in accordance with one embodiment of the present invention; and

FIG. 4 depicts an exemplary method by which the agility of a business offering may be measured, in accordance with one embodiment of the present invention.

### DESCRIPTION OF EXAMPLE EMBODIMENTS

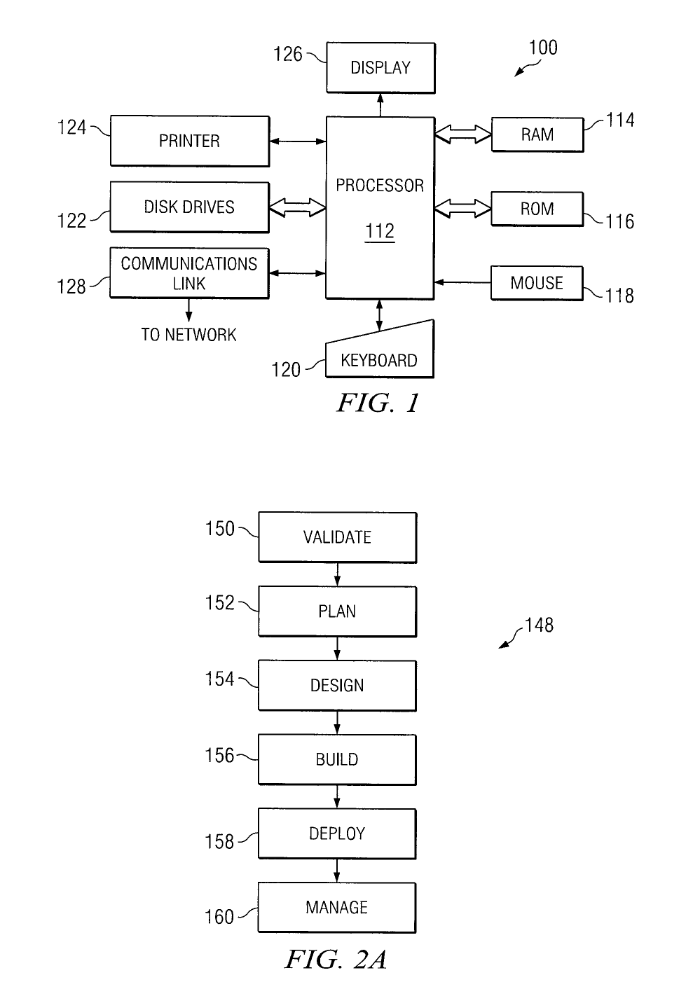

The preferred embodiment of the present invention and its advantages are best understood by referring to FIGS. 1-4 of the drawings, like numerals being used for like and corresponding parts of the various drawings.

There is an increasing need for agile business offerings and business solutions. Whereas offerings built on rigid Information Technology (IT) systems result in inefficient, fragmented business processes, agile business offerings are more able to adapt to changing requirements and market demands. As such, the organizations and the business products offered by such organizations are becoming more flexible and adaptable. In particular embodiments, a business offering may include a system architecture composed of multiple architecture elements. The phrases “business offering,” “business solution,” “offering,” “architecture,” and “system architecture” are used interchangeably throughout the description of the present invention. The change in use of terminology from one to another or to other similar terminology should not be taken to imply a difference in scope of meaning of one term with respect to the others.

The systems and methods of FIGS. 1-4 provide for the accurate measurement of the agile nature of a business offering. The agility measurement takes into account various standardized factors that are considered for each business offering. As a result, the degree to which a solution is agile is an objective determination. The agility measurement does not fall victim to the subjective judgments made by an architect. Using the agility tool described herein, agility is measured rather than sensed. As a result, an objective and quantitative number may be calculated for identifying the agility of a technical solution.

FIG. 1 illustrates a general purpose computer 100 that may be used for the determination of the agility of business offerings developed by an organization, in accordance with the present invention. In certain embodiments, general purpose computer 100 may comprise a computer that enables architects and other organization members to calculate the agility of a business offering. General purpose computer 100 may identify various factors that are used for evaluating the agility or adaptability of a business offering. General purpose computer 100 may take into account that certain factors have a greater effect on the agility of a business offering than other factors. Accordingly, general purpose computer 100 may apply assigned weights to the factors to account for the extent to which a given factor impacts the overall agility of the business offering. Using the assigned weights and one or more user inputs that are based on objective standards and the collective experience of a pool of architects and engineers, general purpose computer 100 computes a quantitative assessment of the agility of the business offering. Specifically, a percentage or other numerical value may be calculated from various user inputs that can then be used to determine if a business offering is Not Agile, Less Agile, Agile, More Agile, and Very Agile. General purpose computer 100 removes the subjectivity that results from sensing rather than measuring the agility of a business offering.

General purpose computer 100 may be adapted to execute any of the well known MS-DOS, PC-DOS, OS2, UNIX, MAC-OS and Windows operating systems or other operating systems. As used in this document, operating system may refer to the local operating system for computer 100, a network operating system, or a combination of both. General purpose computer 100 comprises processor 112, random access memory (RAM) 114, read only memory (ROM) 116, mouse 118, keyboard 120, and input/output devices such as printer 124, disk drives 122, display 126, and communications link 128. The present invention includes programs that may be stored in RAM 114, ROM 116, or disk drives 122 and may be executed by processor 112. Communications link 128 is connected to a computer network but could be connected to a telephone line, an antenna, a gateway, or any other type of communication link. Disk drive 122 may include a variety of types of storage media such as, for example, floppy disk drives, hard disk drives, CD ROM drives, or magnetic tape drives. Disk drive 122 may also include a network disk housed in a server within the private network. Although this embodiment employs a plurality of disk drives 122, a single disk drive 122 could be used without departing from the scope of the invention.

As illustrated, FIG. 1 only provides one example of a computer that may be used with the invention. Those of ordinary skill in the art will appreciate that the hardware in FIG. 1 may vary depending on the implementation. For example, other peripheral devices, such as optical disk drives and the like, may be used in addition to or in place of the hardware depicted in FIG. 1. The depicted example is not meant to imply architectural limitations with respect to the present invention. For example, the processes of the present invention may be applied to multiprocessor data processing systems.

In a particular embodiment, general purpose computer 100 includes an agility tool for measuring the agility of a business offering or a component of a business offering. The agility tool may be stored, for example, on disk drive 122 as a set of computer readable instructions for execution by processor 112. The agility tool utilizes a series of criteria or factors along with a set of customizable weights and scores to quantify the agility of a business offering. A user interface may be provided to receive user inputs with respect to each criteria or factor.

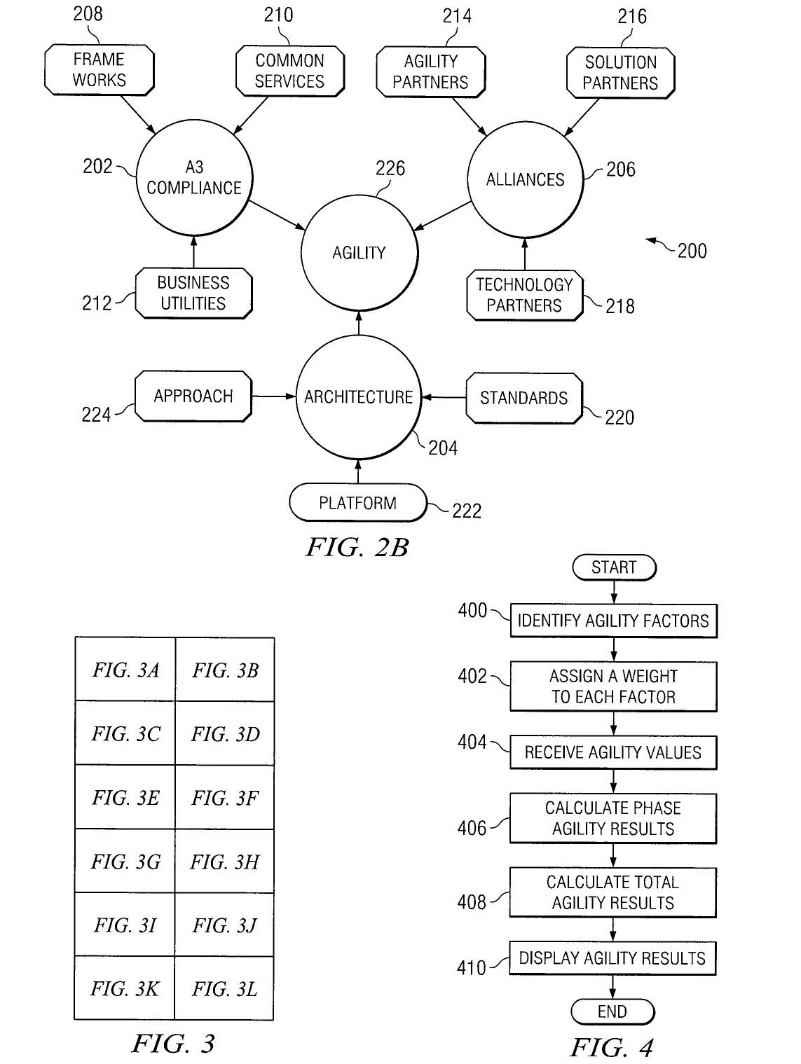

The development of a business offering may be divided into phases. FIG. 2A depicts a flow diagram illustrating the various phases for the development of a business offering, in accordance with a particular embodiment. For example, the agility tool may be used at various points during a Concept-to-Offering (CTO) or Concept-to-Production (CTP) span 148. In a particular embodiment, as illustrated in FIG. 2A, the phases may include a plan phase 152, a design phase 154, a build phase 156, a deploy phase 158, and a manage phase 160. In another example embodiment, an additional validate phase 150 may occur prior to the plan phase 152. As still another alternative, the validate and plan phases may be merged together. Although the exact terminology or order of the phases is not material to the determination of the agility of a business offering, where the development of a business offering is divided into phases, the agility tool may be used to assess the agility of an offering for phases leading up to the Design Phase. For example, after completion of a plan phase 152, the agility of the business offering may be measured to determine if the architect at least intended to build an agile business offering composed of standardized, industry and organization recommended components. As another example, after completion of a design phase 154 the agility of the business offering may be measured to determine if the architect built an offering in such a way to create reusable parts to add to a repository of standardized, industry and organization recommended components.

Additionally or alternatively, the agility tool may be used to assess the agility of an offering through the latest phase to which the offering has progressed. Such assessments may be particularly valuable at any time prior to the beginning of the build phase. For example, after completion of the design phase, the agility of the business offering can be calculated. Such a determination can be used to take appropriate measures to improve the agility of the business offering as it is built and deployed in later phases. In general it is desirable for agility to improve as the development of the business offering progresses through any applicable phase.

FIG. 2B illustrates a methodology 200 including a set of exemplary factors that may be used to measure the agility of a business offering, in accordance with one embodiment of the present invention. The factors capture the elements or characteristics that can be used to measure or predict a business offering's responsiveness to change. A single factor or many factors may be utilized. As illustrated, the factors may be broadly classified into three major categories: compliance 202, architecture 204, and alliance 206. Compliance 202 may include factors relating to whether the components of a business offering comply with an architecture standard adopted by an enterprise. Architecture 204 may include factors relating to the methodologies used to develop the business solution. For example, factors in architecture 204 may relate to the architectural approach used to develop the solution or the platform upon which the solution is developed. Architecture factors may relate to whether the business solution is model driven, service oriented, or event driven or whether architectural standards are being adhered to within the business offering. Alliance 206 may include factors relating to the sources of the components within a business solution and whether those sources have alliances with the organization developing the business solution. Agility may be improved where efficiencies are gained by working with a company's partners.

Factors included in the compliance 202 category may measure the extent to which best practices and guidance promoted by a standard are employed within the solution. Generally, the more standardized the offering, the more agile the offering will be. The agility results from the fact that policy-approved architecture elements are used in the business offering. A standardized system may enforce consistent labels, layouts, taxonomy, and definitions. Using a standard to build a business offering enables the designer to select from pre-defined platforms and design system architectures without knowledge of the details of the underlying physical implementations and platforms. The standard may be one promulgated by the industry, by a standards committee or board, or by the organization providing the business offering. Solutions may be built from pre-existing technologies provided by any number of vendors that are industry promoted. Accordingly, in a particular embodiment, a measure of agility may be determined based on the percentage of the components in the business solution that are “standard picks.” Standard picks may include those components that are tried and true and, thus, are promoted by the industry standard or the organization generating the business solution. One of the measures that contribute to the overall determination of the agility includes the set of components within the business solution that are standard picks divided by the total number of business solution components.

In a particular embodiment, the standard may be defined by architecture templates comprised of combinations of hardware/software components. Additionally, pre-approved combinations or stacks of components may be utilized to improve the agility of a business solution. Thus, a factor may include the extent to which pre-approved combinations or stacks of components have been utilized. For example, the set of components that best map to one or more pre-approved combinations or stacks of components may be computed. This number may be divided by the total number of solution components to result in an agility measurement.

As a further measure of the compliance of the business solution, those business solution components that are neither standard picks nor pre-approved combinations or stacks of components may be identified and their degree of compliance with an enterprise standard may be measured. Non-standard picks that are more compliant with the enterprise standard may increase the agility of the business solution.

In particular embodiments, the factors included in the compliance 202 category may relate to the frameworks 208 used by the offering. For example, a compliance factor may take into consideration the extent to which industry frameworks have been employed during the validation phase. An industry framework may define one or more sets of reusable components that are promoted by the industry. In general, the greater the number of reusable components included in a business offering, the more agile the offering will be. For calculating the agility of the offering, for example, the set of components that are part of leveragable industry frameworks may be divided by the number of total solution components to calculate an agility percentage relating to the underlying framework of the business offering.

Another factor relating to frameworks 208 may include the extent to which the components within an industry provided framework or an enterprise provided framework have been leveraged without any customization. Specifically, this factor determines the extent to which pre-fabricated, pre-built components are being leveraged within the business solution. Generally, the more customization provided in a business solution, the less agile the business solution will be. Accordingly, where a framework is used that is embraced by the industry or by the organization providing the business solution, a more agile business solution may be generated.

Another factor falling within the frameworks 208 category may include the percentage of solution components that are in a plane prescribed within framework embraced by the enterprise. To calculate such a percentage, the number of framework components within the business solution that are not located within the appropriate plane may be determined. This number may be divided by the total number of solution components. The higher the resulting percentage the less agile a business solution is.

In particular embodiments, the factors included in the compliance 202 category may also relate to the common services 210 and/or business utilities 212 used by the offering. Generally, if a component in a business solution is reusable, it has been tested and, thus, is more reliable. Accordingly, to improve the agility of a business solution, an enterprise may promote the usage of “reusable” components from a “reusable repository.” Accordingly, one factor that may be considered with regard to business utilities 212 may include the percentage of the existing reusable, tested business utilities employed within the offering. A business utility may include standard business processes that are executed regardless of the particular industry or business for which the business solution is intended. For example, the provisioning of new business employees on a network is typically standard across various industries and businesses. Accordingly, the process for provisioning new business employees comprises a business utility.

As another example, the percentage of the existing, reusable, tested common services employed within the offering may be calculated. Additionally, the percentage of services that are newly identified common services that may be added to a common services repository for use in future business offerings may be calculated. A common service may include something that is executed across all business processes. For example, requiring an employee to enter a user name and password for authentication purposes before network access is granted is an example of a common service. Finally, it may be desirable to consider business solutions and common services together. For example, a factor may include the percentage of the solution that is assembled using existing, tested, reusable common services and business solutions.

Factors in the Alliance 206 category relate to whether non-standard components are provided by sources that have alliances with the organization developing the business solution. More specifically, factors included in the alliance 206 category may measure the extent to which the components of the business solution are provided by partners of the organization developing the business solution. Generally, a more agile business offering includes components provided by business partners with whom the organization developing the business solution has established technological and financial agreements that are mutually beneficial. Thus, increasing the number of components in the business solution that are provided by such partners will improve the agility of a business offering. Accordingly, one example factor that may be considered includes the percentage of non-standard picks that are provided by a partner organization.

In particular embodiments, the factors included in the alliances 206 category may be divided based on varying types of partnerships. For example, the organization developing the business solution may include different levels of partnerships. Agility partners 214, for example, may include those partners at the highest level of the hierarchy. Agility partners 214 may include those organizations that are the most invested in the development of business solutions by the developing organization. Agility partners 214 may include organizations that are mature, trustworthy, and have developed market play. Thus, for measuring agility, a percentage of the non-standard picks within a business solution that are provided by agility partners 214 may be calculated.

The next level of partners within alliances 206 may include solution partners 216. While organizations comprising solution partners 216 may not include organizations with large market play, such organizations may be very developed in building complete solutions within a specific industry, technology platform or business domain. An organization may be deemed a solution partner 216 where the organization is partnering to develop solutions that may be used in multiple business offerings for multiple clients. Thus, for measuring agility, a percentage of the non-standard picks within a business solution that are provided by solution partners 214 may be calculated.

Another level of partners within alliances 206 may include technology partners 218. Technology partners may include organizations that are very well developed in a particular component of the solution. For measuring agility, a percentage of the non-standard picks within a business solution that are provided by technology partners may be calculated.

An example is provided to illustrate the distinctions between agility partners, solution partners, and technology partners, in a particular embodiment. The example is provided for example purposes only, however. Assume a particular enterprise is in the business of providing complete home office solutions. Agility partners of that enterprise might include those that make a wide variety of office equipment including printers, fax machines, scanners and copiers. Solution partners might include those that provide an integrated solution that has all four in one machine for a particular type of business. For example, a solution partner might provide high-resolution pictures for real-estate or interior decorators or high-volume printing for lawyers, in particular embodiments. Technology partners provide particular types of ink dispensers or scanner components that may very well be an integral part of the solutions provided by Agility and Solution partners. The particular component that the Technology Partner makes is the best of its kind in the world. However, the Technology Partner does not have a complete solution or a broad array of components that that the enterprise incorporates globally into the enterprise's solutions.

Factors in the Architecture 204 category relate methodologies used to develop the business solution. For example, similar to factors in the Compliance 202 category, certain factors in the Architecture 204 category may relate to the standards 220 used to develop the business solution. For example, where the business solution requires two software applications to interact with each other, the agility of the business solution may be affected by the standards being used to allow the two software applications to interact. If the developing organization is making up its own standard, the business solution is likely to be less agile. Conversely, if the developing organization is using an existing standard and/or a standardized language, the business solution is more likely to be agile. Even further, if the standard being used is a standard promoted by the developing organization, the business solution is even more likely to be agile. Example factors that may relate to standards 220 of the Architecture 204 category may include the percentage of the interfaces in the business solution that are using standardized languages such as, for example, WSDL (Web Services Description Language) and BPEL (Business Process Execution Language). Additionally, the percentage of the interfaces that use a preferred technologies such as, for example, XML (Extensible Markup Language) based scripts may be considered. Even if the preferred technologies are not used, agility may be increased where some other standard is being used. Thus, a factor may include determining the percentage of interfaces that are not XML based but are based on some other standard.

The agility of the business solution may also be affected by the platform on which the business solution is developed. For example, if an organization uses JAVA and Net as platforms, it is desirable for a business solution to be executable on both of these platforms. The question arises: are standard platforms used? Thus, the Architecture 204 category of factors may include one or more factors relating to platform 222. For example, a factor may include determining how heterogeneous a solution is. Such a calculation may require that the total number of solution components be determined. This number may be divided by the maximum number of solution components deployed in a given platform. This ratio may establish the degree to which the business solution is heterogeneous. A business solution that is more heterogeneous is less agile than a business solution that is more homogeneous. As stated above, it is desirable for a business solution to be deployable regardless of the operating system used. A more homogeneous business solution may be used in a broad variety of networked solutions.

In particular embodiments, a more homogenous solution may be well-integrated as its own end-to-end solution component that can be plugged into other solutions in a modular fashion. While the component may not be an integral part of the solution itself, the component may be built into the solution in an agnostic fashion with a standardized interface to the solution. Take, for example, the CD player in an automobile. Rather than manufacture the CD player as an integral part of the automobile itself, the CD player is built in an automobile agnostic fashion with a standardized interface to the automobile. Thus, in theory, any CD player can be readily installed in any automobile. This is the concept of plug-and-play. A homogeneous solution, like the CD player, has a better chance of being employed in a plug-and-play fashion in any environment. Heterogeneity may result in interfaces that may not be as standardized.

Other factors that may increase or decrease the agility of the business solution may relate to the approach used in developing the business solution. Thus, the Architecture 204 category may include one or more factors relating to Approach 224. Such factors may include the percentage of the solution that has been or can be defined by a platform independent model from which code can be generated and reverse-engineered. Other factors may include the percentage of the solution that has been or can be represented by Use Cases whose realization can be adequately measured. Use Case represents what the application is doing from a user's perspective and, thus, what the user experiences when interacting with the business solution.

Still other Approach 224 factors may include the percentage of the solution that has been or can be represented by activity or sequence diagrams that represent the interactions between the solution components. Sequence diagrams include detailed representations of the all process interactions including the backend process interactions that the user doesn't see. Due to project budget constraints, deadlines, or limited marketing resources, the development of activity or sequence diagrams may be skipped and the business solution may be built without performing these tasks. However, quality is typically compromised when these steps are omitted. As such, a more agile business solution will include a higher percentage of the solution that has been or can be represented by activity or sequence diagrams. Documentation of the interactions between processes using sequence diagrams facilitates expeditious analysis of the impact of any changes. Accurate analysis of the impact increases the accuracy of the manner in which the changes are implemented. Hence, the availability of the sequence diagrams makes the overall solution considerably more agile.

The factors described above are just some examples of factors that may be used in measuring the overall agility 226 of a business solution. It will be recognized that other factors may be additionally or alternatively considered during the assessment of the agility of a business offering.

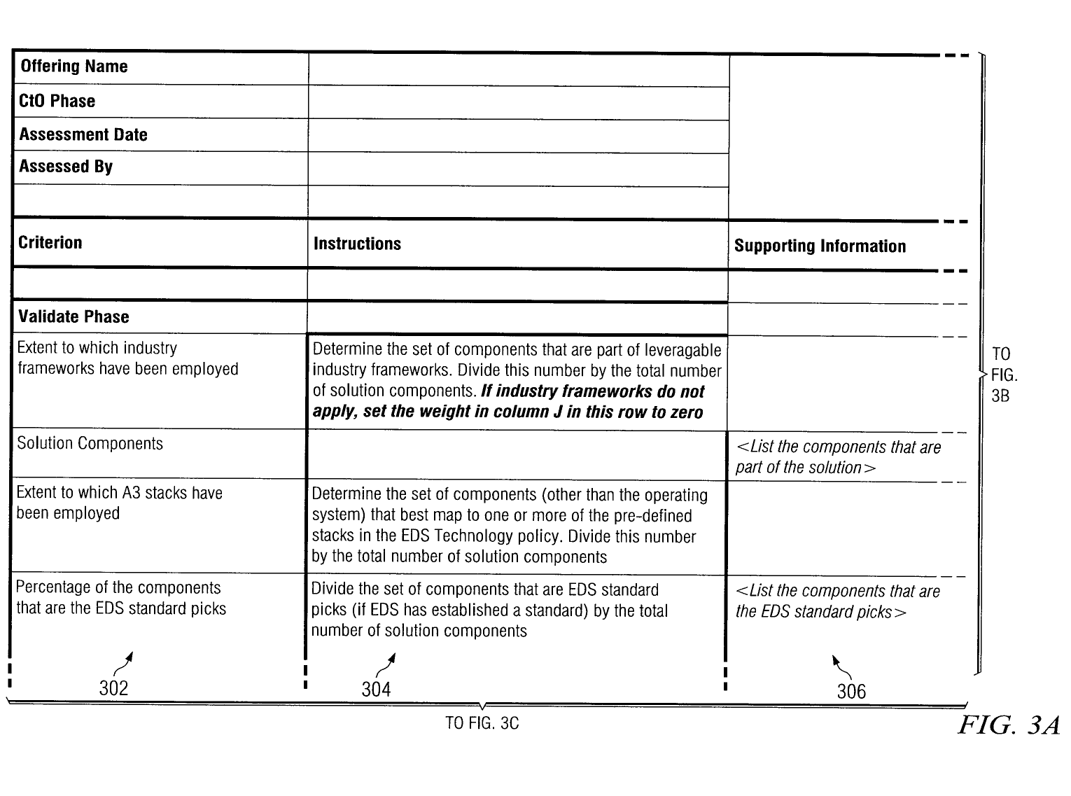

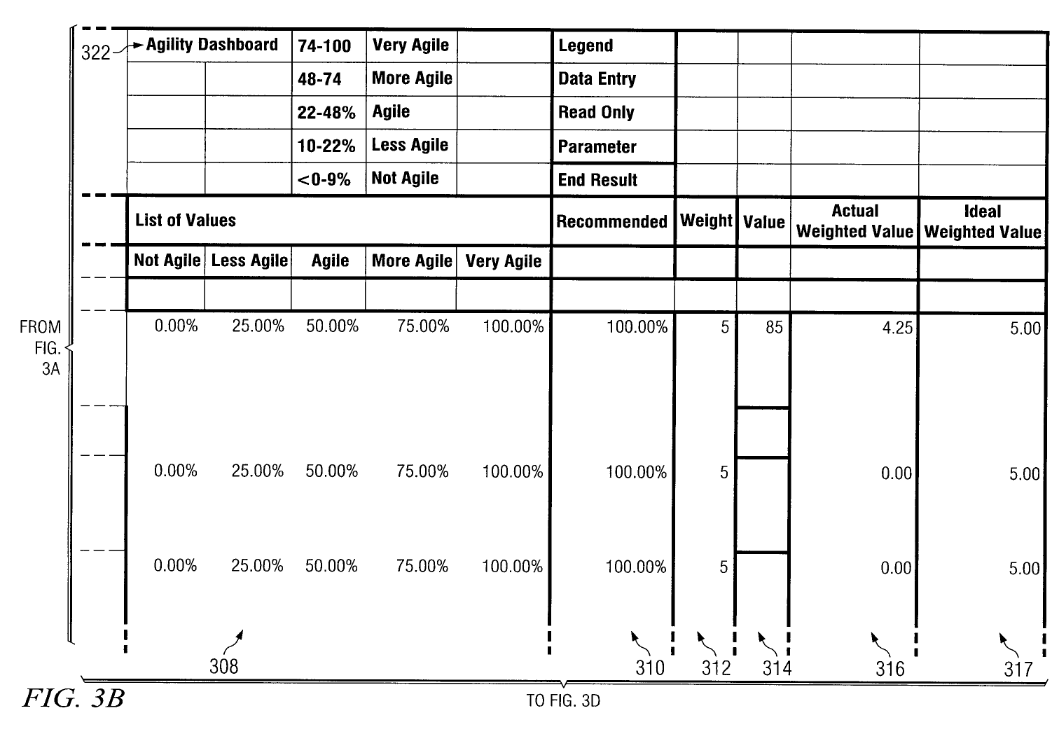

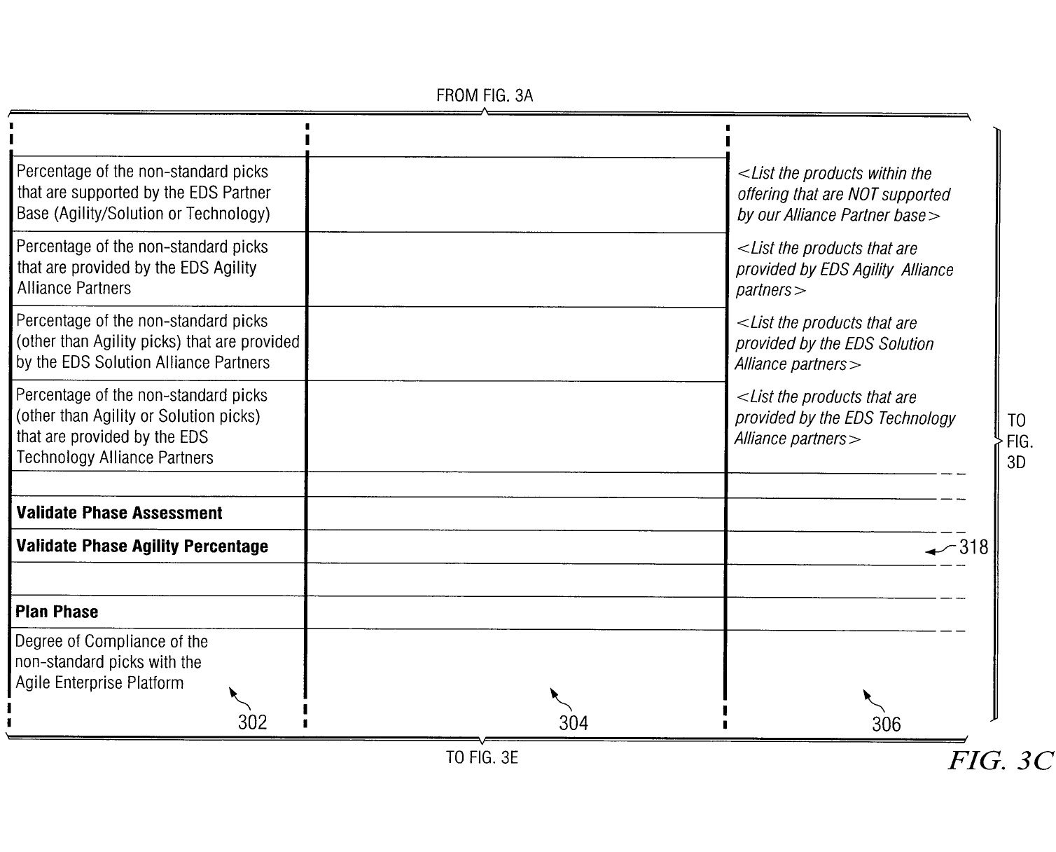

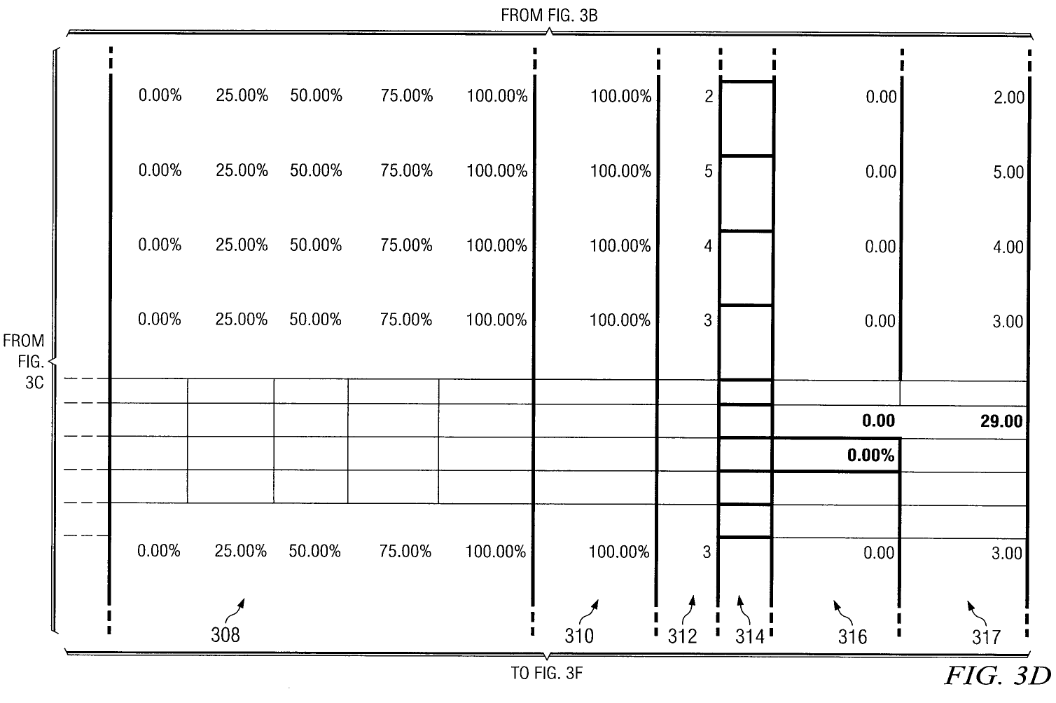

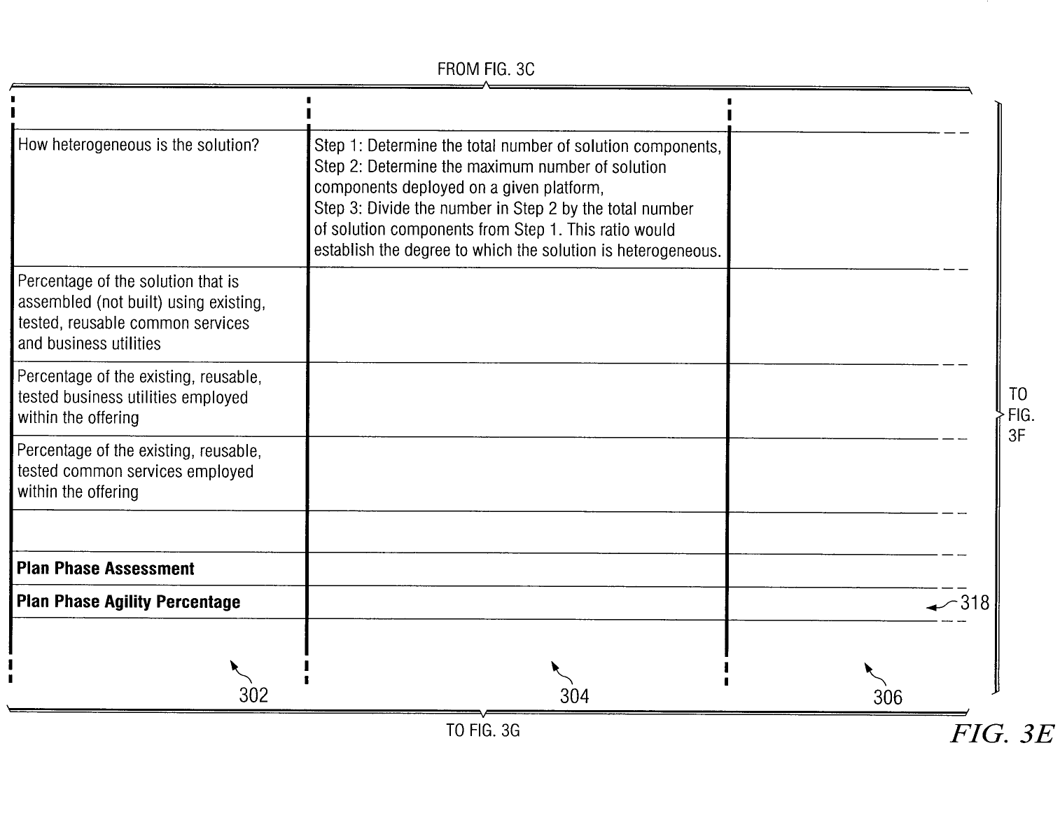

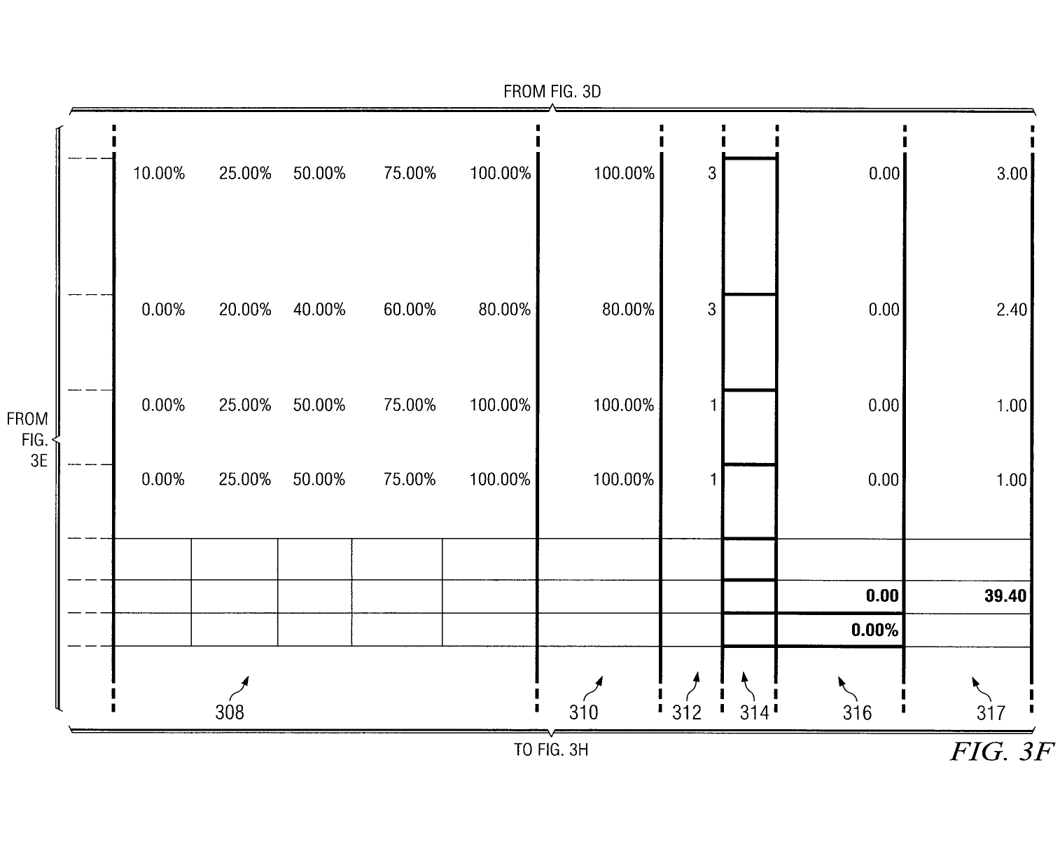

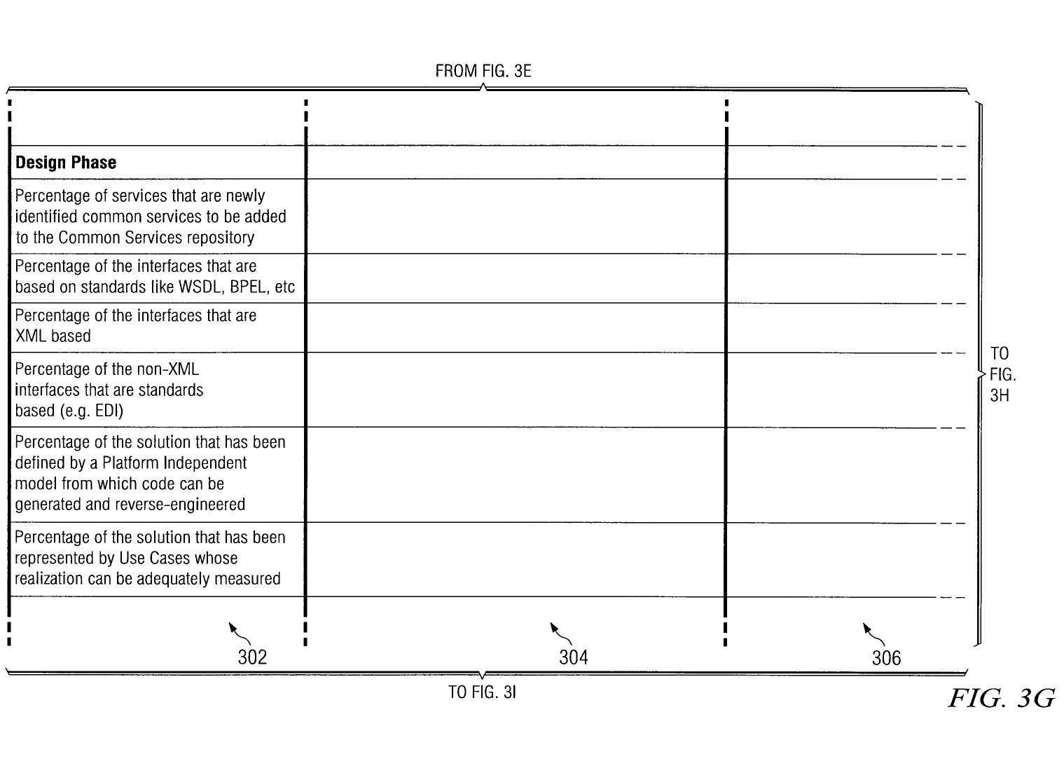

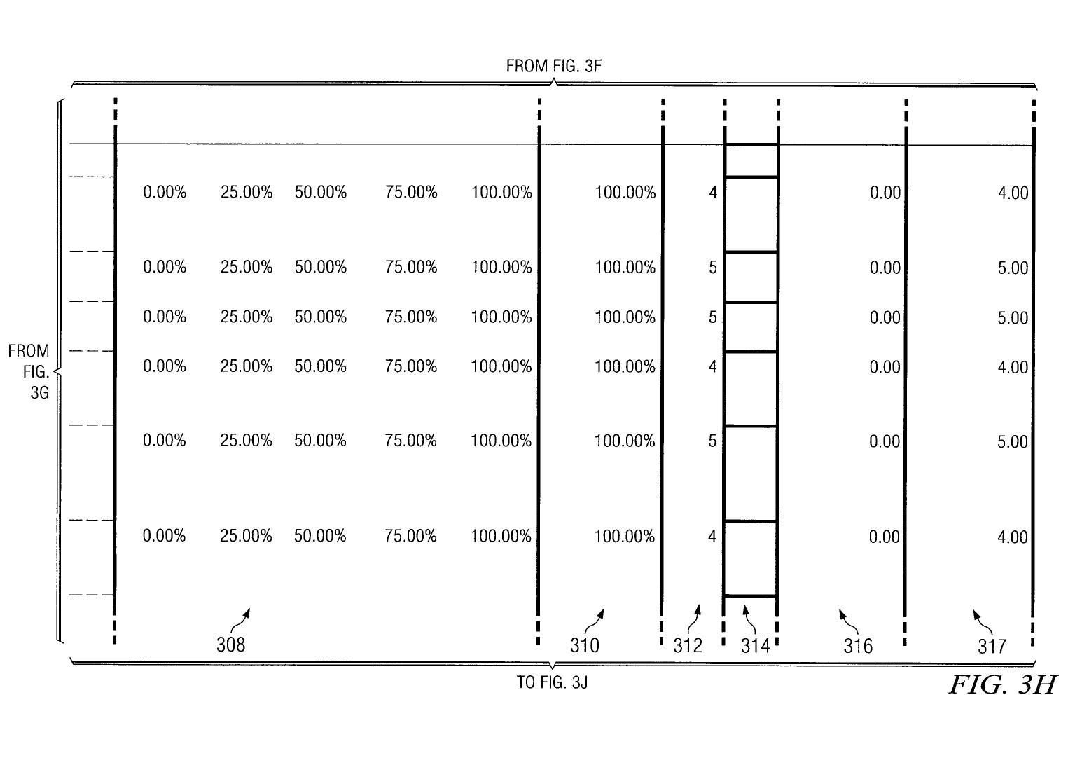

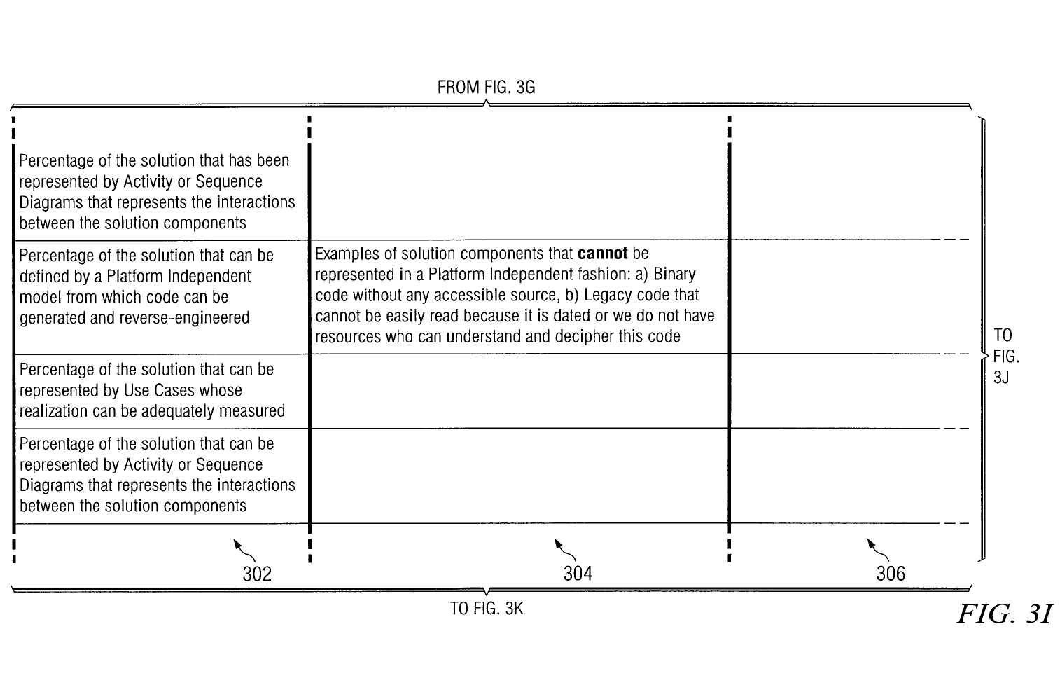

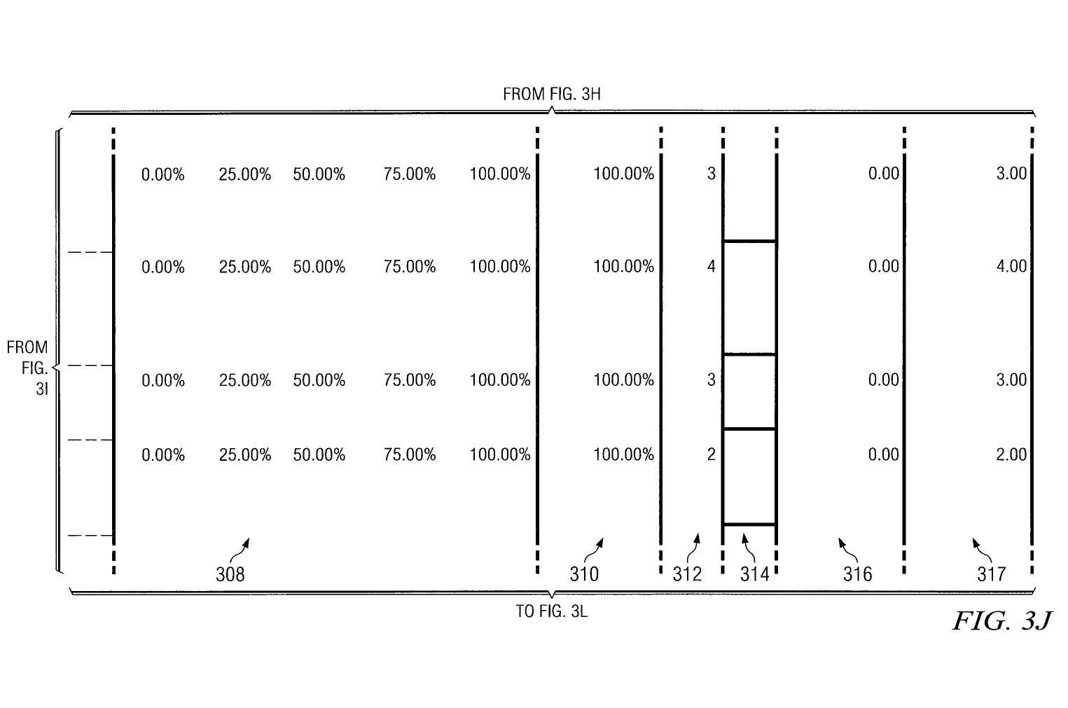

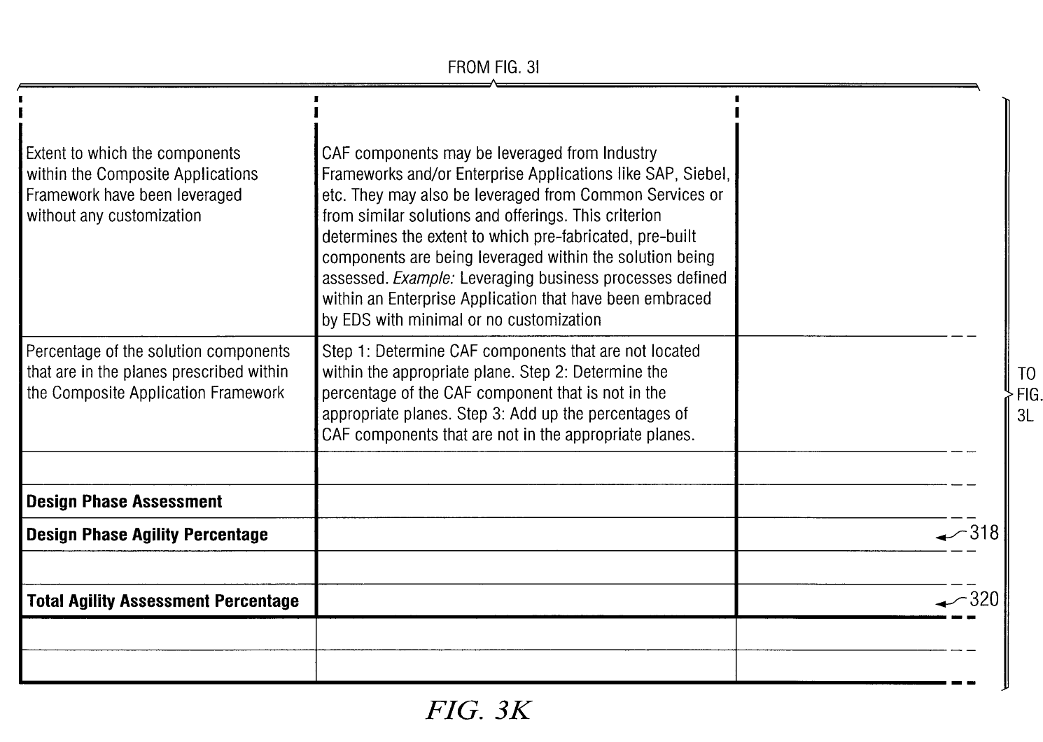

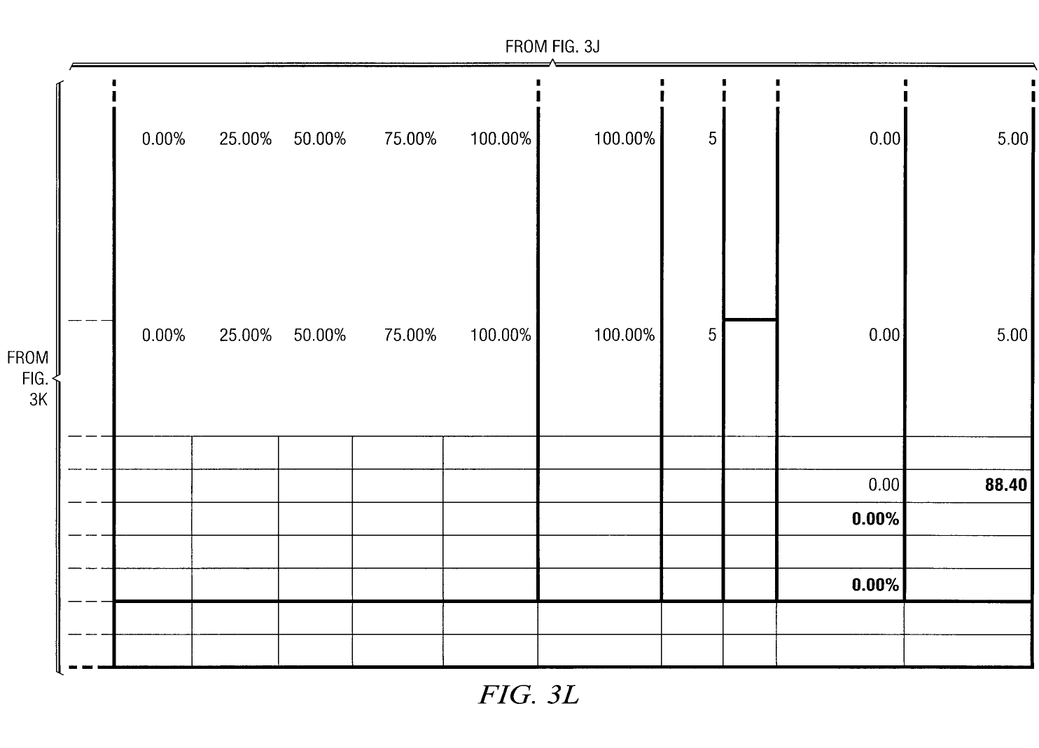

For the calculation of an agility value, the agility tool may include a user interface that enables an architect or other system user to input values for each of the factors included in the determination of the agility of the business offering. The inputs may be incorporated into a worksheet that computes one or more agility ratings for each phase of development and/or an overall agility rating for the business offering upon completion of one or more phases of development. FIG. 3 illustrates an exemplary agility tool worksheet 300 for calculating the agility of a business offering, in accordance with one embodiment of the present invention. However, agility tool worksheet 300 is merely one example of a user interface that may be used to determine a quantitative assessment of the adaptability of a business offering. Those skilled in the art will recognize that other user interfaces may be utilized as well.

As illustrated, a first column 302 of worksheet 300 lists each factor or criteria to be considered in the agility determination. Additionally, the factors are divided into various phases during the development of the business offering, and the factors are ordered accordingly. For example, the validate phase 150 includes the following factors: extent to which industry frameworks have been employed, extent to which pre-existing stacks have been employed, percentage of the components that are standard picks, percentage of the non-standard picks that are supported by a partnership base, and percentage of the non-standard picks that are provided by particular partnership bases.

A user of worksheet 300 is required to provide a value for each of the factors listed in the first column. To aid the user in the determination of the correct values to be input into worksheet 300, worksheet 300 includes a second column 304 that includes instructions to direct the user in the proper use of worksheet 300. For example, instructions are provided to a user to help the user determine the extent to which industry frameworks have been employed. In the illustrated example, the instructions direct the user to determine the set of components that are part of leveragable industry frameworks and divide that number by the total number of solution components. However, where the instructions are self-explanatory, the instructions of column 304 may be omitted with respect to one or more factors.

A third column 306 of worksheet 300 is provided for additional user input that comprises supporting information relating to each factor. For example, a user is asked to “list the components that are part of the solution” with respect to the factor relating to stacks that have been employed. Providing supporting information allows the architect or other user to easily identify components within the business offering that are improving or hindering the agility of the business offering.

The fourth through eighth columns of the worksheet 300 comprise a list of agility values 308 for each factor. Specifically, for each factor, a list of agility values is identified for multiple agility categories ranging from not agile to very agile. For example, with regard to the “Extent to which industry frameworks have been employed” factor, the following agility values are provided: 0% is identified as being “not agile,” 25% is identified as being “less agile,” 50% is identified as being “agile,” 75% is identified as being more agile, and 100% is identified as being very agile. The agility values provided may vary for each factor 302 where appropriate.

The ninth column 310 of worksheet 300 provides a recommended agility value. The recommended value is the ideal value that would result in a determination that the business offering is Very Agile. Typically, the recommended agility value is 100% since it represents the ideal scenario. However, in some instances, a value of 100% may be unattainable under any circumstances. Accordingly, the recommended agility value may be adjusted to reflect what is attainable. For example, it may not be possible to completely assemble a solution with existing, tested, reusable common services and business utilities. Accordingly, as shown on worksheet 300, the factor relating to the “Percentage of the solution that is assembled using existing, tested, reusable common services and business utilities” has a recommended value of 80%, which is provided as an ideal and attainable goal.

The tenth column 312 of worksheet 300 identifies the weight that is assigned to each factor 302. The weight identifies the extent to which the given criterion impacts the overall agility of the offering. The weights are based on the expertise of consultants and may be specific to the type of business solution. The weights assigned to the factors may result from the analysis of empirical data. The analysis may be based on business offerings that are considered agile and business offerings that are not. Then, through the applications of data mining and statistical analysis, the contribution of each factor and, thus, the associated weight for each factor is determined.

Not all factors will contribute the same amount to the agility of the business offering. Because some factors may affect the agility more than others, a higher weight may be assigned to those factors having a greater affect on the agility of the business offering. For example, the heterogeneous nature of the business solution may affect the agility of a business offering more than the percentage of existing, tested, and reusable components. As such, on worksheet 300, the weight for the factor relating to the “heterogeneous nature of the offering” is set at 3 while the weight for the factor relating to the “reusability” of the components is set to 1.

The eleventh column 314 of worksheet 300 is for user inputs. As described above, a user calculates an agility value for each factor in worksheet 300. The user uses the list of agility values 308 for each factor and any instructions 304 provided to determine an agility value to be input in eleventh column 314 for each factor. For example, with regard to the first factor listed in the validate phase 150, the user may determine the set of components in the business solution that are part of one or more leveragable industry frameworks. The obtained number may be divided by the total number of solution components. The resulting number is a percentage that falls within the 0-100% range. The user then puts the resulting number into the appropriate field of the eleventh column 314. For example, if the user determines that 85 components of a total of 100 components are part of one or more leveragable industry frameworks, the user enters a value of 85% in eleventh column 314. Although this is just one example of determining an agility value, an appropriate methodology may be used to identify an agility value for each factor listed in worksheet 300 to the extent that all phases of the development lifecycle have been completed.

Worksheet 300 uses the values input by the user to calculate an actual weighted value for each factor. The actual weighted values appear in twelfth column 316. The actual weighted value comprises the agility value assigned by the user multiplied by the appropriately assigned weight. For example, with regard to the first factor in the validate phase 150 of worksheet 300, the actual weighted value is calculated as follows:

0.85×5=4.25

In this manner, an actual weighted value is calculated for each factor and is depicted in twelfth column 316.

The actual weighted value of twelfth column 316 may be compared with an ideal weighted value in thirteenth column 317. In contrast to the actual weighted value, the ideal weighted value is the recommended agility value of ninth column 310 multiplied by the weight assigned to the factor. Thus, the ideal weighted value for the first factor in the validate phase 150 of worksheet 300 is 5.00.

As illustrated, worksheet 300 provides an agility percentage 318 for each phase of the development lifecycle. The agility percentage 318 for each phase is computed by dividing the sum of all the actual weighted values calculated for each factor in a phase divided by the sum of all of the ideal weighted values calculated for each factor in the phase. The agility percentage 318 quantifies the extent or percentage to which the offering is agile for a particular phase. Additionally, a total agility assessment percentage 320 identifies the total agility of the business offering over all phases. The total agility assessment percentage 320 quantifies the extent or percentage to which the offering is agile for all considered phases.

The agility percentages 318 and the total agility assessment percentages 320 may be compared with an agility dashboard 322. As illustrated the agility dashboard 322 identifies a percentage of 74-100 as being associated with a Very Agile business offering. A percentage of 48-74 is associated with a More Agile business offering, and a percentage of 22-48 is associated with an Agile offering. Finally, a percentage of 10-22 is associated with a Less Agile offering, and a percentage less than 10% is associated with a Not Agile offering. A user can determine where the agility percentages 318 and total agility assessment percentages 320 fall within the agility dashboard 322 and identify the agility of the business offering. However, the agility dashboard as illustrated, is merely one example. The percentages and ranges may vary as appropriate.

FIG. 4 illustrates an exemplary process by which a quantitative assessment of the agility of a business offering may be calculated in accordance with one embodiment of the present invention. The method begins at step 400 when a plurality of agility factors are identified. In a particular embodiment, the business offering comprises a plurality of components, and each of the plurality of agility factors may be related to a characteristic of the components within the business offering. For example, one or more factors may relate to the architectural approach for the business offering. As another example, one or more factors may relate to whether a standard is being adhered to in the business offering. As still another example, one or more factors may relate to the underlying platform upon which the business offering is built. Factors may also relate to whether the source of components within the business offering are alliance partners of the organization developing the business offering.

At step 402, a weight is assigned to each agility factor. The weights may indicate a relevant contribution that each agility factor has on the overall adaptability of a business offering. Agility values for at least a portion of the agility factors may be received at step 404. Each agility value may be selected from a finite number of selection numerals that represent a range of adaptability from low to high for a given agility factor for the business offering. In a particular embodiment, the agility values may be received as user inputs by way of a user interface. In a particular embodiment, each of the plurality of agility factors may be assigned to a phase of development of the business offering. For example, each agility factor may be assigned to a validate phase 150, a plan phase 152, a design phase 154, or any other suitable phase that may occur in the development lifecycle. At step 406, a phase agility result is calculated for each of the phases of the development of the business offering. Each phase agility result may be calculated using the user inputs for each factor in a selected phase and the weights assigned to the particular factors in each phase.

At step 408, a total agility result is calculated for the business offering. In a particular embodiment, the user inputs of agility values and the weights assigned to each agility factor may be used to calculate the total agility result. The agility result provides a quantitative assessment of the adaptability of the business offering.

Although particular steps have been described with reference to FIG. 4, the present invention contemplates any suitable methods in accordance with the present invention. Thus, certain of the steps described with reference to FIG. 4 may take place substantially simultaneously and/or in different orders than as shown and described. Moreover, components of system 100 may use methods with additional steps, fewer steps, and/or different steps, so long as the methods remain appropriate.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links. The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

While the system and method described herein objectively computes the agility of an offering across multiple phases of the Concept to Production lifecycle, the information collected by its employment across multiple offerings can be consolidated to identify behavioral patterns within various domains like industries (Manufacturing, Communication, Transportation etc.), Service Lines (Applications, Infrastructure, Networking, Security etc.). This information could also be represented at an enterprise level in a dashboard that would provide a snapshot of the agility of the enterprise as a whole addressing key performance indicators like: a) What percentage of the offerings are Very Agile? b) What are the criteria that typically bring down the average agility of offerings?, c) Which is the phase of the CtP process where offerings demonstrate the maximum improvement in agility? Extension of the described systems and methods to realize this consolidation of information is possible because the data is collected in a consistent format during the execution of a standardized process for all offerings. Each instance of the methodology used will translate into a record of useful information. Multiple records may be analyzed to identify the trends that will help enterprises improve their overall agility.

Further, while the system and method herein may be used to objectively compute the agility of an offering, the described concepts may also be applied with a revised set of criteria to capabilities. A capability is a defined set of competencies required to deliver solutions and services based on one or more offerings. Agile offerings are most effectively delivered by Agile Capabilities. Capabilities need to be able to react quickly to changing business demands and technological progress across the globe—in other words, capabilities need to be agile as well. Agile offerings do not necessarily ensure agile capabilities. Capabilities need to assess themselves and take appropriate measures to improve their own agility.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method for measuring and assessing the agility of a business offering, the method comprising:
creating a plurality of agility factors that can be used to measure a responsiveness of a business offering to change;
assigning a weight to each agility factor, each weight indicating a relevant contribution of an associated agility factor to the responsiveness of the business offering;
receiving user inputs of agility values for at least a portion of the plurality of agility factors; and
using the user inputs of agility values and the weight assigned to each agility factor to calculate an agility result, wherein the agility result provides a quantitative assessment of the adaptability of the business offering.

2. The method of claim 1, wherein the business offering comprises a plurality of components, and wherein each of the plurality of agility factors are related to at least one characteristic of at least one component within the business offering.

3. The method of claim 1, wherein each of the plurality of agility factors are assigned to a selected one of a plurality of groups, each of the plurality of groups associated with a phase of the development of the business offering.

4. The method of claim 3, further comprising calculating a phase agility result for each phase during the design of the business offering, each phase agility result calculated using the user inputs for an associated factor in a selected phase.

5. The method of claim 3, wherein the plurality of groups comprise a validate group, a plan group, and a design group.

6. The method of claim 3, wherein the plurality of groups comprise a plan group and a design group.

7. The method of claim 1, wherein each of the user inputs of agility values is selected from a finite number of selection numerals that represent a range of adaptability from low to high for a given agility factor for the business offering.

8. The method of claim 1, wherein at least one of the plurality of agility factors relates to the architectural approach for the business offering.

9. The method of claim 1, wherein at least one of the plurality of agility factors relates to whether a standard is being adhered to in the business offering.

10. The method of claim 1, wherein at least one of the plurality of agility factors relates to the underlying platform upon which the business offering is built.

11. The method of claim 1, wherein at least one of the plurality of agility factors relates whether the source of components within the business offering comprises an alliance partner of an organization developing the business offering.

12. A system for measuring and assessing the agility of a business offering, the system comprising:
a database storing an agility application for assessing the responsiveness of a business offering to change;
a user interface operable to display an agility worksheet to a user and receive user inputs of agility values from the user; and
a processor in communication with the database, the processor operable to:
create a plurality of agility factors that can be used to measure the responsiveness of the business offering to change;
assign a weight to each agility factor, each weight indicating a relevant contribution of an associated agility factor to the responsiveness of the business offering;
receive the user inputs of agility values for at least a portion of the plurality of agility factors;
use the user inputs of agility values and the weight assigned to each agility factor to calculate an agility result, wherein the agility result provides a quantitative assessment of the adaptability of the business offering; and
cause the agility result to be displayed to the user on the display.

13. The system of claim 12, wherein the business offering comprises a plurality of components, and wherein each of the plurality of agility factors are related to at least one characteristic of at least one component within the business offering.

14. The system of claim 12, wherein each of the plurality of agility factors are assigned to a selected one of a plurality of groups, each of the plurality of groups associated with a phase of the development of the business offering.

15. The system of claim 14, wherein the processor is further operable to calculate a phase agility result for each phase prior to the production of the business offering, each phase agility result calculated using the user inputs for an associated factor in a selected phase.

16. The system of claim 14, wherein the plurality of groups comprise a validate group, a plan group, and a design group.

17. The system of claim 14, wherein the plurality of groups comprise a plan group and a design group.

18. The system of claim 12, wherein each of the user inputs of agility values is selected from a finite number of selection numerals that represent a range of adaptability from low to high for a given agility factor for the business offering.

19. The system of claim 12, wherein at least one of the plurality of agility factors relates to the architectural approach for the business offering.

20. The system of claim 12, wherein at least one of the plurality of agility factors relates to whether a standard is being adhered to in the business offering.

21. The system of claim 12, wherein at least one of the plurality of agility factors relates to the underlying platform upon which the business offering is built.

22. The system of claim 12, wherein at least one of the plurality of agility factors relates whether the source of components within the business offering comprises an alliance partner of an organization developing the business offering.

23. A method for measuring and assessing the agility of a business offering, the method comprising:
creating a plurality of agility factors that can be used to measure a responsiveness of a business offering to change, wherein the business offering comprises a plurality of components, and wherein each of the plurality of agility factors are related to at least one characteristic of at least one component within the business offering, wherein each of the plurality of agility factors are assigned to a selected one of a plurality of groups, each of the plurality of groups associated with a phase of the development of the business offering;
assigning a set of weights to each agility factor, each weight indicating a relevant contribution of an associated agility factor to the responsiveness of the business offering;
receiving user inputs of agility values for at least a portion of the plurality of agility factors, wherein each of the user inputs of agility values is selected from a finite number of selection numerals that represent a range of adaptability from low to high for a given agility factor for the business offering;
using the user inputs of agility values and the weight assigned to each agility factor in each phase to calculate an phase agility result for each phase during the development of the business offering; and
using the user inputs of agility values and the weight assigned to each agility factor to calculate an total agility result, wherein the total agility result provides a total quantitative assessment of the adaptability of the business offering.
